(19) United States
(12) Patent Application Publication
(10) Pub. No.: US 2012/0232971 A1
(43) Pub. Date: Sep. 13, 2012

(54) METHOD AND APPARATUS FOR PROVIDING A CUSTOMIZABLE REWARD SYSTEM

(75) Inventors: Michael Keith Pabst, Mountain View, CA (US); Jingshen Jimmy Zhang, Stanford, CA (US); Wedge Martin, Mountain View, CA (US); Kris Duggan, Palo Alto, CA (US)

(73) Assignee: Badgeville, Inc.

(21) Appl. No.: 13/043,100

(22) Filed: Mar. 8, 2011

(51) Int. Cl. G06Q 30/00

(52) U.S. Cl. 705/14.12; 705/14.27

(57) ABSTRACT

A method for providing a customizable reward service may include monitoring user activity associated with a web site relative to an operator defined lexicon of activities, comparing user activity to conditional rules defining multidimensional behaviors and corresponding rewards associated with satisfaction of the conditional rules, and determining whether to generate a reward from an operator defined lexicon of rewards based on satisfaction of the conditional rules. A corresponding apparatus is also provided.

### TECHNOLOGICAL FIELD

An embodiment of the present invention relates generally to reward system technology and, more particularly, relates to a method and apparatus for providing or utilizing a reward system that is customizable to reward various different web or network activities.

### BACKGROUND

The development of communication technology enabling users to access networks like the Internet, has led to an explosion in the number of individuals that own devices capable of accessing network information sources and services. As these individuals navigate through online networks in search of information, media content, services and the like, they create opportunities for many marketers to reach out to them to try to advertise goods and services. Much like a highly visible location along a major freeway, a site that boasts a large amount of traffic can be fertile ground for advertisers to reach potential customers. More traffic may also mean a higher likelihood that the content and/or services provided by the site may be requested or purchased by those visiting the site. Thus, there has been a tremendous amount of competition for user traffic.

Web site designers typically want people to have a good user experience that will be remembered, cause return visits, and perhaps also be described to others to increase traffic even further. Thus, web site designers essentially would like to influence user behavior to reliably influence users to desire certain content or services that the web site may provide. Furthermore, the creation of user loyalty can cause return visits and also lead to expansion of traffic by word of mouth.

There are many tools that exist for promoting content or services and performing analysis of user behavior. For example, sales force automation (SFA) systems typically allow marketers to send emails with links to a publisher web site. The SFA system may then support reporting of mass emailing and clicks back into the system from the email. However, each such interaction requires an email to be sent and a report to be generated for each link or page. Thus, such a system is not a scalable way to promote all content on a site where there may be hundreds or thousands of pages.

Some web sites have taken another approach to influencing user behavior by offering rewards for certain behaviors. However, the rewards that are offered are typically specifically designed using very simple rule sets that are applicable only to a specific web site. Thus, supporting sophisticated rules and business logic has been a challenge.

### BRIEF SUMMARY

A method and apparatus is therefore provided to enable the provision of a customizable reward system. In this regard, for example, some embodiments may provide for a dynamic game engine to apply game mechanics to the problem of influencing human behavior. Accordingly, some embodiments may expand reward systems to create a highly flexible platform that can be applied to any of a plurality of different web sites or services and enable the corresponding web sites or services to generate a reward system that is specific to their respective needs. In other words, some example embodiments may provide a turnkey solution for use by any web site or service to tailor their own rewards program.

In one example embodiment, a method of providing a customizable reward system is provided. The method may include monitoring user activity associated with a web site relative to an operator defined lexicon of activities, comparing user activity to conditional rules defining multidimensional behaviors and corresponding rewards associated with satisfaction of the conditional rules, and determining whether to generate a reward from an operator defined lexicon of rewards based on satisfaction of the conditional rules.

In another example embodiment, an apparatus for providing a customizable reward system is provided. The apparatus may include processing circuitry configured to perform at least monitoring user activity associated with a web site relative to an operator defined lexicon of activities, comparing user activity to conditional rules defining multidimensional behaviors and corresponding rewards associated with satisfaction of the conditional rules, and determining whether to generate a reward from an operator defined lexicon of rewards based on satisfaction of the conditional rules.

### BRIEF DESCRIPTION OF THE DRAWING(S)

Having thus described some embodiments of the invention in general terms, reference will now be made to the accompanying drawings, which are not necessarily drawn to scale, and wherein:

FIG. 1 is a schematic block diagram of a system according to an example embodiment of the present invention;

FIG. 2 illustrates a block diagram of an apparatus for providing a customizable reward service according to an example embodiment of the present invention;

FIG. 3 illustrates a reward loop according to an example embodiment of the present invention; and

FIG. 4 is a flowchart according to an example method for providing a customizable reward service according to an example embodiment of the present invention.

### DETAILED DESCRIPTION

Some embodiments of the present invention will now be described more fully hereinafter with reference to the accompanying drawings illustrating some embodiments of the invention. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the term ‘circuitry’ refers to hardware-only circuit implementations (e.g., implementations in analog circuitry and/or digital circuitry), combinations of circuits and software and/or firmware instructions stored on one or more non-transitory computer readable memories that work together to cause an apparatus to perform one or more functions described herein, and circuits, such as, for example, a microprocessor or a portion of a microprocessor, that requires software or firmware for operation even if the software or firmware is not physically present. As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As indicated above, some embodiments of the present invention may relate to the provision of a turnkey solution or platform for leveraging social game techniques to drive human behavior. In particular, example embodiments may define a customizable reward system that employs a dynamic game engine to define specific behavior and corresponding specific rewards. Moreover, some example embodiments may provide for the game engine to be flexible enough to enable multidimensional behaviors to be defined along with corresponding rewards to be associated with the multidimensional behaviors. Thus, nearly any technically describable behavior may be rewarded by nearly any technically describable reward. Example embodiments may be used to engage user interest and enthusiasm to build brand loyalty to a web site employing such example embodiments. In this regard, example embodiments employ highly sophisticated rewards and incentives rules and structures to drive human behavior based at least in part on social loyalty.

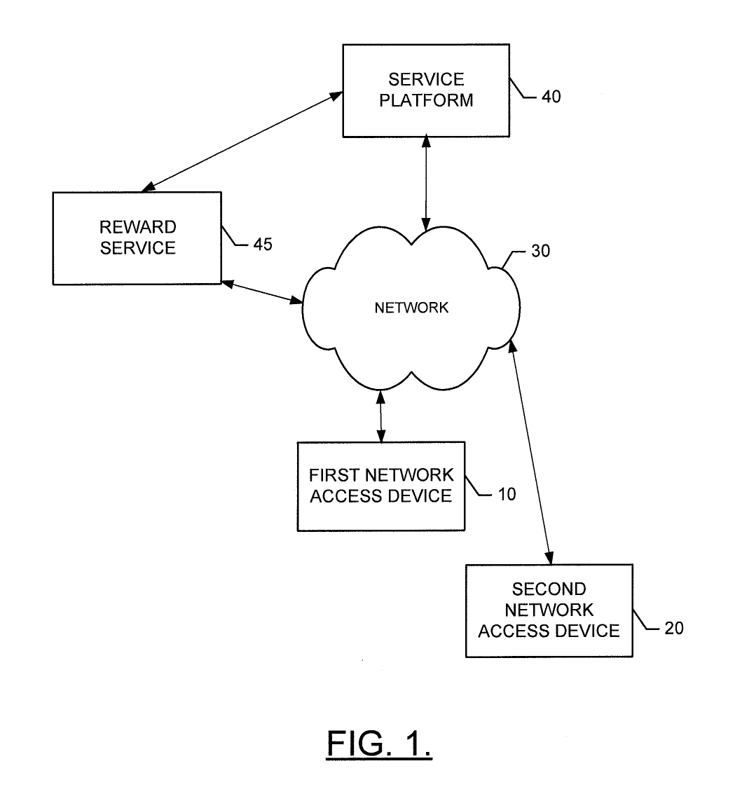

FIG. 1 illustrates a generic system diagram illustrating some alternative system architectures that may support some example embodiments. In this regard, as shown in FIG. 1, a system in accordance with an example embodiment of the present invention may include one or more network access devices (e.g., a first network access device 10 and a second network access device 20) that may each be capable of accessing network content via a network 30 according to an example embodiment.

The second network access device 20 is provided as an example to illustrate potential multiplicity with respect to instances of other devices that may be capable of communication with the network 30 and that may practice an example embodiment. The network access devices of the system may be able to communicate with network devices or with each other via the network 30 in some situations. In some cases, the network devices with which the network access devices of the system communicate may include a service platform 40 from which information can be pulled, or from which information may be pushed. In an example embodiment, the network access devices may be enabled to communicate with the service platform 40 to provide, request and/or receive information.

As indicated above, the first and second network access devices 10 and 20 that are illustrated may be examples of user terminals that are configured to enable user interface with the respective devices and also provide access to network content and/or services. In some embodiments, the first and second network access devices 10 and 20 may be computing devices such as personal computers (PCs), laptop computers, personal digital assistants (PDAs), smart phones, hand held computers, or other such devices. Each network access device may include some form of user interface (e.g., a display, speakers, and/or other output devices in combination with a mouse, touch screen, joystick, microphone, voice recognition system, wireless pointer, menu selection device such as a remote control or other input device) to enable user selections to be provided to the device as an input and various types of content to be provided as an output. It should also be noted that the first and second network access devices 10 and 20 may be either mobile or fixed devices in some examples. However, is should also be noted that not all systems that employ embodiments of the present invention may comprise all the devices illustrated and/or described herein.

In an example embodiment, the network 30 includes a collection of various different nodes, devices or functions that are capable of communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of wireless or wired communication protocols. Thus, in some examples, one or more of the first and second network access devices 10 and 20 may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (e.g., personal computers, server computers or the like) may be coupled to the first and second network access devices 10 and 20 via the network 30. By directly or indirectly connecting the first and second network access devices 10 and 20 and other devices to the network 30, the first and second network access devices 10 and 20 may be enabled to communicate with the other devices (or each other), for example, according to numerous communication protocols including Hypertext Transfer Protocol (HTTP) and/or the like, to thereby carry out various communication or other functions of the first and second network access devices 10 and 20, respectively.

Furthermore, although not shown in FIG. 1, the first and second network access devices 10 and 20 may communicate in accordance with, for example, radio frequency (RF), Bluetooth (BT), Infrared (IR) or any of a number of different wireline or wireless communication techniques, including USB, LAN, wireless LAN (WLAN), Worldwide Interoperability for Microwave Access (WiMAX), WiFi, ultra-wide band (UWB), Wibree techniques and/or the like. As such, the first and second network access devices 10 and 20 may be enabled to communicate with the network 30 by any of numerous different access mechanisms. For example, mobile access mechanisms such as wideband code division multiple access (W-CDMA), CDMA2000, global system for mobile communications (GSM), general packet radio service (GPRS), long term evolution (LTE) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 40 may be a device or node such as a server or other processing device. The service platform 40 may have any number of functions or associations with various services. As such, for example, the service platform 40 may be a platform such as a dedicated server (or server bank) associated with a particular information source or service (e.g., a web site or service), or the service platform 40 may be a backend server associated with one or more other functions or services. As such, the service platform 40 represents a potential host for a plurality of different services or information sources. Moreover, in some cases, the service platform 40 may represent multiple entities and thus, communications and/or exchanges internal to the service platform 40 may actually include communications and/or exchanges between separate entities and/or organizations. In some embodiments, the functionality of the service platform 40 is provided by hardware and/or software components configured to operate in accordance with known techniques for the provision of information and/or services to users of communication devices such as the first and second network access devices 10 and 20. However, at least some of the functionality provided by the service platform 40 may be information provided in accordance with an example embodiment of the present invention.

In various example embodiments, the service platform 40 may be configured to provide a web site or web services to users capable of accessing the network 30. The web site or service with which the service platform 40 is associated may be virtually any type of activity. Thus, for example, the service platform 40 may be configured to provide content or services associated with an online retailer, a social network, a content provider (e.g., music, news, information, videos, data, etc.), search engine, and/or the like. According to example embodiments, the web site or service associated with the service platform 40 may wish to influence user behavior with respect to their web site or service and may therefore utilize an example embodiment of the present invention. In one embodiment, the service platform 40 may include a MongoDB, document-oriented database and a Ruby on Rails application. However, this is merely one example implementation.

In an example embodiment, a reward service 45 including a dynamic game engine 50 may also be included in the system. As such, the reward service 45 may be enabled to communicate with the service platform 40 to exchange information or content with the service platform 40 via the network 30. Thus, in some example embodiments, the reward service 45 may be configured to provide services to the service platform in relation to a customizable reward service. As such, in some embodiments, the reward service 45 may employ a local version of the dynamic game engine 50 to actually monitor activity associated with the web site or service of the service platform 40 and generate rewards based on that activity according to the processes described herein. However, in other example embodiments, the reward service 45 may be configured to provide an instance of the dynamic game engine 50 (or data useable to instantiate an instance of the dynamic game engine 50) to the service platform 40 for employment at the service platform 40. Furthermore, in at least one example embodiment, the reward service 45 may be configured to operate offline or independent of the network 30. In such an example, the reward service 45 may provide an instance of the dynamic game engine 50 (or data useable to instantiate an instance of the dynamic game engine 50) to the service platform 40 via a transferable storage medium such as a compact disc (CD), digital video disc (DVD), flash memory, or other removable memory device that may be transferred between devices and enable content stored thereon to be extracted by or otherwise provided to a recipient device (e.g., the service platform 40).

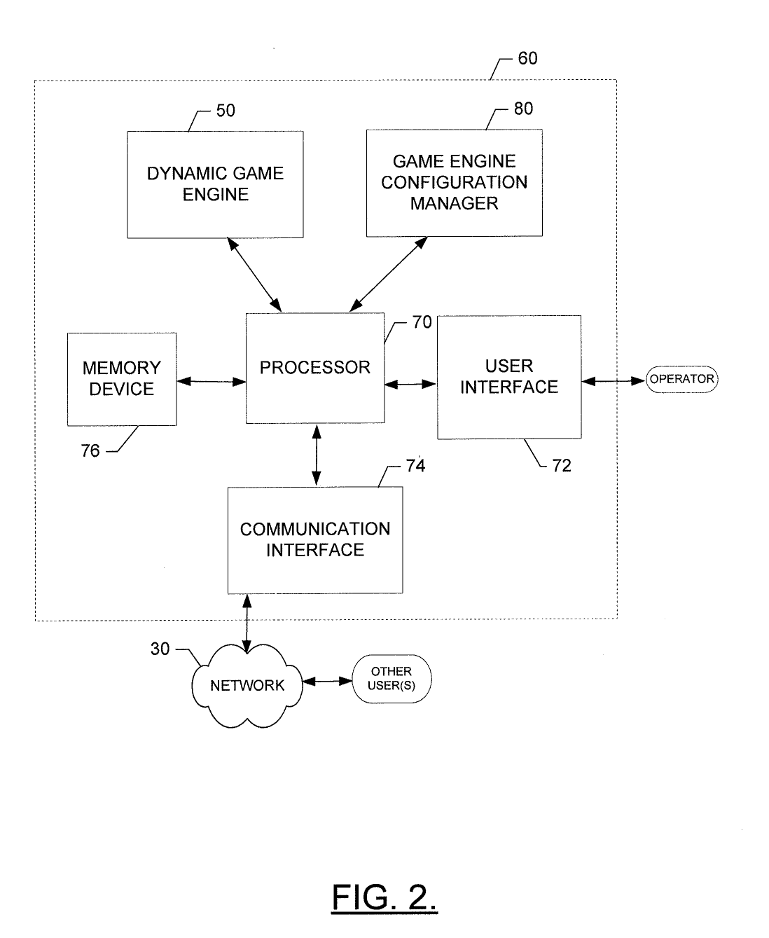

The dynamic game engine 50 may include or otherwise utilize hardware and/or software developed to enable social game techniques to be employed to drive user behavior as described herein and shown in FIG. 2. FIG. 2 illustrates a schematic block diagram of an apparatus for providing a customizable reward system according to an example embodiment of the present invention. An example embodiment of the invention will now be described with reference to FIG. 2, in which certain elements of an apparatus 60 for providing a customizable reward system are displayed. The apparatus 60 of FIG. 2 may be employed, for example, on the reward service 45. However, the apparatus 60 may also be employed on the service platform 40 or any other device employing an example embodiment. Moreover, it should be noted that the devices or elements described below may not be mandatory and thus some may be omitted in certain embodiments.

Referring now to FIG. 2, the apparatus 60 may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 60. The memory device 76 may include, for example, one or more volatile and/or non-volatile memories. In other words, for example, the memory device 76 may be an electronic storage device (e.g., a non-transitory computer readable storage medium) to store data that may be retrievable by a machine (e.g., a computing device like the processor 70). The memory device 76 may be configured to store information, data, applications, instructions or the like for enabling the apparatus 60 to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

As indicated above, the apparatus 60 may, in some embodiments, be the reward service 45, the service platform 40 or some other communication device or computing device configured to employ an example embodiment of the present invention. However, in some embodiments, the apparatus 60 may be embodied as a chip or chip set. The processor 70 may be embodied in a number of different ways. For example, the processor 70 may be embodied as one or more of various processing means such as a coprocessor, a microprocessor, a controller, a digital signal processor (DSP), or various other processing circuitry including integrated circuits such as, for example, an ASIC (application specific integrated circuit), an FPGA (field programmable gate array), a hardware accelerator, or the like. As such, in some embodiments, the processor 70 may include one or more processing cores configured to perform independently.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., the reward service 45 or the service platform 40) adapted for employing an embodiment of the present invention by further configuration of the processor 70 by instructions for performing the algorithms and/or operations described herein.

The communication interface 74 may be any means such as a device or circuitry embodied in either hardware, or a combination of hardware and software, that is configured to receive and/or transmit data from/to a network and/or any other device or module in communication with the apparatus 60. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. The processor 70 and/or user interface circuitry comprising the processor 70 may be configured to control one or more functions of one or more elements of the user interface 72 through computer program instructions (e.g., software and/or firmware) stored on a memory accessible to the processor 70 (e.g., memory device 76, and/or the like). The user interface 72 may be remote in some instances, temporarily connectable, or even eliminated entirely (e.g., after initial programming of the dynamic game engine 50) in some example embodiments.

An operator may be enabled, via the user interface 72, to provide instructions with respect to creation of a reward loop to be instituted by the dynamic game engine 50 with respect to activities of users with respect to the service platform 40. As such, in some examples, the user interface 72 may be used to define multidimensional behaviors and the corresponding rewards that are to be associated with respective different sets of multidimensional behaviors.

In an example embodiment, the processor 70 may be said to cause, direct or control the execution or occurrence of the various functions attributed to the dynamic game engine 50 and a game engine configuration manager 80 (and components thereof) as described herein. The dynamic game engine 50 and the game engine configuration manager 80 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the dynamic game engine 50 and the game engine configuration manager 80, respectively, as described herein. Thus, in examples in which software is employed, a device or circuitry (e.g., the processor 70 in one example) executing the software forms the structure associated with such means.

The dynamic game engine 50 may be configured to be responsive to the operation of the game engine configuration manager 80. The game engine configuration manager 80 may be configured to receive input (e.g., from an operator) defining basic data models for activities, activity definitions, rewards and reward definitions. The activities may define actions or behaviors that may be performed in connection with a web site such as a web service or game. The rewards may define specific reward responses that can be earned for completing a series of actions. The reward definitions may specify which series of actions or behaviors constitute rewardable actions or behaviors. The activity definitions may provide the criteria to determine which activities or behaviors match a reward definition and rules for modifying or normalizing the corresponding activities. Thus, the activities may provide a lexicon for all possible activities that can be considered for a particular web site (e.g., associated with the service platform 40) and the rewards may define a lexicon for all possible rewards that may be awarded. The activities may include actions or events that occur only within the context of the web site itself (e.g., clicking certain content, logging in, submitting comments, etc.) or that occur outside the specific context of the web site, but are observable and can be correlated to events that occur within the context of the web site (e.g., measuring user location via GPS coordinates, reported external activity (e.g., weight loss, exercise and/or the like), engaging in activity at another site, being proximate to a beacon, other user or point of interest, etc.).

The reward definitions may associate specific activities to a status of being worthy of a reward or otherwise meritorious activities, and the activity definitions may associate specific multidimensional activities or behaviors with a corresponding reward definition. As such, the game engine configuration manager 80 may be configured to define a reward data model used to configure the dynamic game engine 50 for operation to execute the reward loop. The dynamic game engine 50 may be configured to monitor user activity associated with a web site relative to an operator defined lexicon of activities, compare that user activity to conditional rules defining multidimensional behaviors and corresponding rewards associated with satisfaction of the conditional rules, and determine whether to generate a reward from an operator defined lexicon of rewards based on satisfaction of the conditional rules.

As may be appreciated from the description above, the reward data model may be an extremely flexible tool that may be used by any web site to allow site designers to tailor the dynamic game engine 50 to their specific web site. The specific activities that are desirable by the web designers may be identified. The specific rewards that are desirable for awarding may also be identified, and correlations between the activities and rewards may be made so that when the reward loop is run, desirable actions are rewarded using the rewards prescribed. The rewards may be virtual or tangible. Thus, for example, the rewards may be badges, status symbols, reputational rewards, points, or other virtual awards and/or redeemable points, coupons, discounts, access to services/goods, or other tangible rewards. The actions that trigger rewards may be multidimensional. Thus, for example, the triggering actions may define any number of related or even unrelated actions that, when recognized as having occurred in connection with a particular user (or group of users that are associated with each other), cause a reward to be issued. A such, a set of behaviors or observed actions may be considered to be multidimensional, if the set of behaviors is defined by actions that cover multiple characteristics or multiple categories of characteristics.

The provision of a lexicon of actions or behaviors and rewards that are possible for a specific site may provide the dynamic game engine 50 with an insight into the possibilities for both activity and reward within a particular context (e.g., as defined by the specific site). Thus, in some embodiments, the dynamic game engine 50 may not only administer the reward loop according to the configuration provided by the game engine configuration manager 80, but the dynamic game engine 50 may also monitor and/or analyze user activity and make suggestions or recommendations regarding rewards (from the known reward lexicon) that may be provided for certain actions (also from the known action or activity lexicon) that are being recognized via the monitoring.

In an example embodiment, the game engine configuration manager 80 may include or otherwise act as a definition builder for enabling the rewards and activities lexicons to be provided and the conditions associated with rewarding to be defined. In some cases, the game engine configuration manager 80 may provide a graphical interface to facilitate the provision of the definitions described above. For example, the game engine configuration manager 80 may be configured to provide a graphical interface to allow an operator or user to define the activities or behaviors that are possible within the context of a particular web site (e.g., associated with the service platform 40). In some cases, text fields may be used to define some or all of the activities or behaviors. However, in other cases, a listing of known or common activities may be provided and the user may select those that are applicable in the context of the particular web site. This may supplement or replace the use of text fields in some examples.

The same mechanism may be used to define rewards. In other words, common rewards (or any previously defined rewards of which the game engine configuration manager 80 is aware) may be provided and the user may select applicable rewards, or the user may define the rewards in text fields. As such, reward templates may be defined. Rewards may have properties that the user can define including, for example, name, description, active period, recurrence, creator, image (e.g., badge, trophy, etc.), point value (static or as a percentage based on a reward allocation), type (e.g., virtual or tangible), rules, instance limit, and/or the like.

In some embodiments, the game engine configuration manager 80 may be configured to also provide a graphical interface for construction of the multidimensional reward definitions and activity definitions. In an example embodiment, templates may be provided for construction of the reward definitions and activity definitions. The templates may be configured to allow conditions to be defined by selection of at least one activity from the activity lexicon. In some cases, the at least one activity may be selected in combination with numerical instance criteria (e.g., a number specifying the number of repetitions of the activity that are required to trigger the condition), time criteria (e.g., an amount of time or period over which behavior may be tracked for satisfaction of a corresponding activity related condition), frequency criteria (e.g., a number of repetitions required within a given time period) and/or the like. Group associations may also be specified, such that activities of all members of the group may be considered together with respect to determinations of eligibility for reward issuance to all members of the group responsive to satisfaction (e.g., by aggregate group activity) of corresponding reward issuance criteria. Boolean expressions may be provided to link various actions, criteria and/or conditions. The graphical interface templates may also provide options to continue to add additional conditions.

The graphical interface may also provide templates for defining rewards. In some cases, the rewards may be selectable from a drop down menu based on the reward lexicon to be linked to the conditions defined using the graphical interface. Since the conditions may include any number of activity based criteria that can each be defined in terms of different (or the same) time, frequency, repetition or other thresholds, and may be defined on an individual or group basis, the conditions may be considered to be multidimensional. Thus, the graphical interface may provide a relatively intuitive mechanism by which operators can establish multidimensional action based rules. As such, the graphical interface may provide a “rules wizard” to enable the operator to relatively easily define rules for the provision of rewards to users.

In most instances, an operator may be enabled to configure the dynamic game engine 50 by interface directly with the game engine configuration manager 80. However, in some complex cases, the operator may request assistance from the reward service 45 for solving certain specific or complex problems. In such examples, operators at the reward service 45 may interact (e.g., online or offline) with operators at the service platform 40 to provide a textual programming interface that exposes querying and map-reduce functionality to further assist in achieving goals for reward provision at the service platform 40.

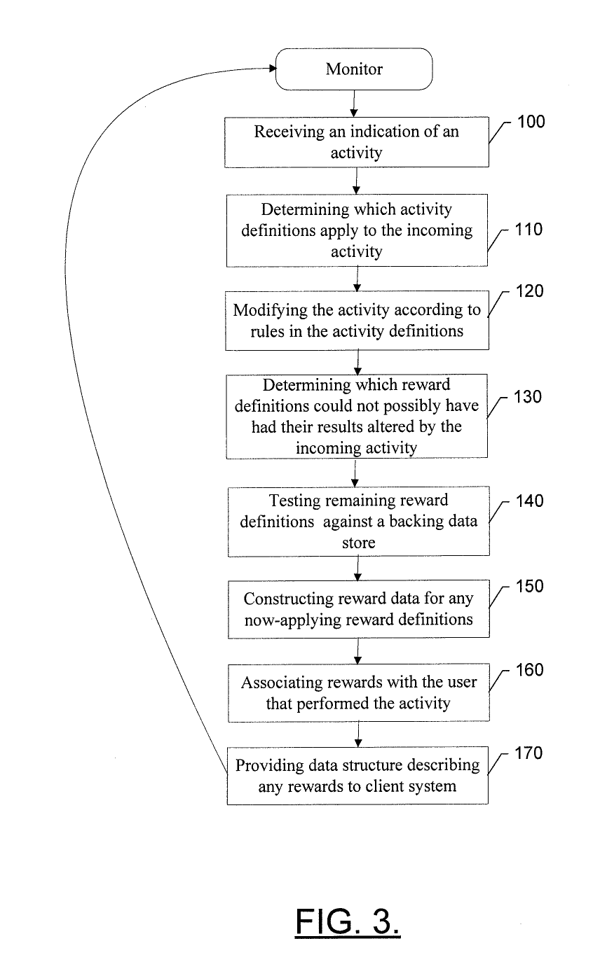

After configuration of the dynamic game engine 50, the dynamic game engine 50 may monitor user activity at the service platform 40 on a per user basis, or on a group basis for any recognizable and defined groups of users. The monitoring may be a part of the reward loop executed by the dynamic game engine 50. FIG. 3 illustrates an example of the reward loop according to one possible embodiment. In an example embodiment such as that which is shown in FIG. 3, the reward loop may include receiving an indication of an activity at operation 100. The indication may also include an identity of the individual performing the activity. At operation 110, a determination may be made as to which activity definitions apply to the incoming activity. At operation 120, the activity may be modified according to rules in the activity definitions. At operation 130, a determination may be made as to which reward definitions could not possibly have had their results altered by the incoming activity. Remaining reward definitions may then be tested against a backing data store, now that the backing data store includes the new activity at operation 140. Reward data may then be constructed for any now-applying reward definitions at operation 150. At operation 160, the rewards may be associated with the user (or other entity) that is indicated in the activity to have performed the activity, to thereby “award” that reward to the corresponding user. The awarding of the reward may then be saved. A data structure describing any rewards from operations 150 and 160 may then be provided to the client system that submitted the activity (e.g., the service platform 40) at operation 170.

As an example, a reward definition may be defined such that, during a 30 day window, IF a user registers for an event AND views related or sponsored content on the publisher's site AND performs a geo-location check-in on the day of the event, THEN the user is eligible to receive a reward. When all conditions are met, the reward may be allocated to the user. The reward may be in the form of a badge, achievement points, a title, or any other visualizable content or redeemable item.

In some cases, the dynamic game engine 50 may be configured to enable the user to see one or more rewards that may be achievable in association with the site (e.g., via selection of a menu option or icon). For example, the user may be enabled to select a “reward library” or other repository for reward data. The user may select interesting rewards and view the corresponding conditions pertaining to the activities needed to achieve the rewards. In some cases, the user selection may further act as a request for the user to be notified of progress toward achieving the selected reward. For example, as each condition is satisfied, the user may receive an indication to inform the user of the satisfaction of the condition and perhaps also to inform the user of remaining conditions that must be met before the reward can be achieved. However, in other cases, users may be informed of their progress relative to any reward in response to the user completing any activity that is associated with any reward. For example, the user may receive a report in a pop-up window to indicate “Did you know that you are half way to achieving the X reward?” and the user may then be enabled to select the X reward to see what it is and how to complete the achievement of the reward.

In an example embodiment, the operators of the site may select whether to provide automatic notification if any action is performed that pertains to a reward, if a threshold number of conditions are met for achievement of a reward, or no notifications at all. Operators may also enable users of the service platform 40 to select their own notification paradigm. As such, the dynamic game engine 50 may enable operators (e.g., web site personnel or designers) and users (e.g., visitors to the web site) to participate in customization of the reward experience. The user may then be more likely to be engaged in the reward process and seek to achieve the rewards that interest them. Since the operators may configure the dynamic game engine 50 such that the rewards may be tailored to provide incentives for users to engage in desirable behaviors, the dynamic game engine 50 may be an effective way to influence user behavior and allow a business owner associated with the web site to achieve his or her business objectives. For example, user interest may be created and user loyalty may be fostered.

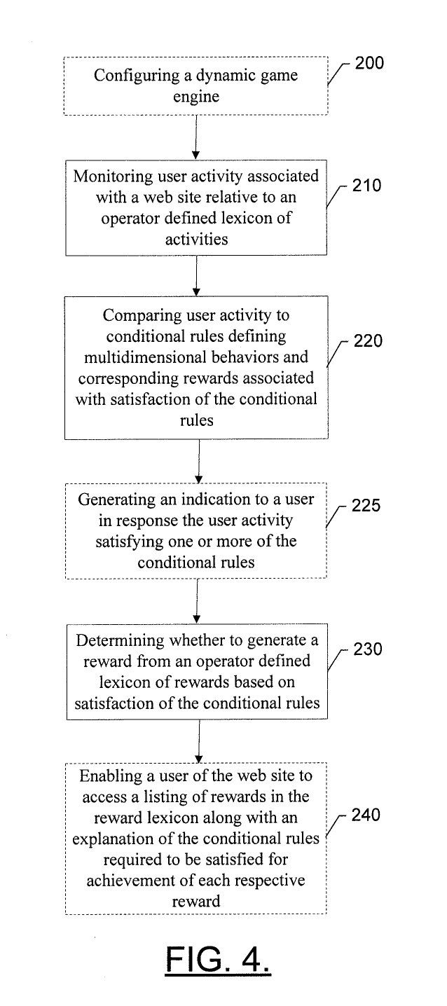

FIG. 4 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal or network device and executed by a processor in the user terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 4, may include monitoring user activity associated with a web site relative to an operator defined lexicon of activities at operation 210, comparing user activity to conditional rules defining multidimensional behaviors (where the behaviors are monitored activities) and corresponding rewards associated with satisfaction of the conditional rules at operation 220, and determining whether to generate a reward from an operator defined lexicon of rewards based on satisfaction of the conditional rules at operation 230.

In some embodiments, certain ones of the operations above may be modified or further amplified as described below. Moreover, in some embodiments additional optional operations may also be included (some examples of which are shown in dashed lines in FIG. 4). It should be appreciated that each of the modifications, optional additions or amplifications below may be included with the operations above either alone or in combination with any others among the features described herein. In this regard, in some embodiments the method may further include an initial operation of configuring a dynamic game engine to perform the monitoring, comparing and determining at operation 200. The configuration may be accomplished by utilizing input received from an operator of the web site to define the lexicon of activities, define the lexicon of rewards, provide reward definitions to specify a series of actions that trigger issuance of each respective reward, and provide activity definitions to determine which activities match each reward definition. In some embodiments, the activity definitions may further provide rules for modifying or normalizing each activity. In an example embodiment, the method may further include generating an indication to a user in response the user activity satisfying one or more of the conditional rules at operation 225 and/or enabling a user of the web site to access a listing of rewards in the reward lexicon along with an explanation of the conditional rules required to be satisfied for achievement of each respective reward at operation 240. In some embodiments, configuring the dynamic game engine may include generating a graphical interface to enable the operator to define each one of the multidimensional behaviors. In an example embodiment, generating the graphical interface may include enabling the operator to define the multidimensional behaviors by selecting one or more activities in association with selected ones of time criteria, frequency criteria, numerical instance criteria, or group association information linkable with Boolean expressions to define the conditional rules. In some examples, the monitoring and the determining whether to generate the reward are each performed by an entity remote from a service platform hosting the web site. However, the monitoring and the determining whether to generate the reward could alternatively each be performed by an entity locally at a service platform hosting the web site.

In an example embodiment, an apparatus for performing the method of FIG. 4 above may comprise a processor (e.g., the processor 70) configured to perform some or each of the operations (200-240) described above. The processor may, for example, be configured to perform the operations (200-240) by performing hardware implemented logical functions, executing stored instructions, or executing algorithms for performing each of the operations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
monitoring user activity associated with a web site relative to an operator defined lexicon of activities;
comparing user activity to conditional rules defining multidimensional behaviors and corresponding rewards associated with satisfaction of the conditional rules; and
determining whether to generate a reward from an operator defined lexicon of rewards based on satisfaction of the conditional rules.

2. The method of claim 1, further comprising an initial operation of configuring a dynamic game engine to perform the monitoring, comparing and determining.

3. The method of claim 2, wherein configuring the dynamic game engine comprises utilizing input received from an operator of the web site to define the lexicon of activities, define the lexicon of rewards, provide reward definitions to specify a series of actions that trigger issuance of each respective reward, and provide activity definitions to determine which activities match each reward definition.

4. The method of claim 3, wherein the activity definitions further provide rules for modifying or normalizing each activity.

5. The method of claim 2, wherein configuring the dynamic game engine comprises generating a graphical interface to enable the operator to define each one of the multidimensional behaviors.

6. The method of claim 5, wherein generating the graphical interface comprises enabling the operator to define the multidimensional behaviors by selecting one or more activities in association with selected ones of time criteria, frequency criteria, numerical instance criteria, or group association information linkable with Boolean expressions to define the conditional rules.

7. The method of claim 1, wherein the monitoring and the determining whether to generate the reward are each performed by an entity remote from a service platform hosting the web site.

8. The method of claim 1, wherein the monitoring and the determining whether to generate the reward are each performed by an entity locally at a service platform hosting the web site.

9. The method of claim 1, further comprising generating an indication to a user in response the user activity satisfying one or more of the conditional rules.

10. The method of claim 1, further comprising enabling a user of the web site to access a listing of rewards in the reward lexicon along with an explanation of the conditional rules required to be satisfied for achievement of each respective reward.

11. An apparatus comprising processing circuitry configured with stored instructions to cause the apparatus to perform at least:
monitoring user activity associated with a web site relative to an operator defined lexicon of activities;
comparing user activity to conditional rules defining multidimensional behaviors and corresponding rewards associated with satisfaction of the conditional rules; and
determining whether to generate a reward from an operator defined lexicon of rewards based on satisfaction of the conditional rules.

12. The apparatus of claim 11, wherein the processing circuitry is further configured to cause the apparatus to perform an initial operation of configuring a dynamic game engine to perform the monitoring, comparing and determining.

13. The apparatus of claim 2, wherein the processing circuitry is configured to cause the apparatus to configure the dynamic game engine by utilizing input received from an operator of the web site to define the lexicon of activities, define the lexicon of rewards, provide reward definitions to specify a series of actions that trigger issuance of each respective reward, and provide activity definitions to determine which activities match each reward definition.

14. The apparatus of claim 13, wherein the activity definitions further provide rules for modifying or normalizing each activity.

15. The apparatus of claim 12, wherein the processing circuitry is further configured to cause the apparatus to configure the dynamic game engine by generating a graphical interface to enable the operator to define each one of the multidimensional behaviors.

16. The apparatus of claim 15, wherein the processing circuitry is further configured to cause the apparatus to generate the graphical interface by enabling the operator to define the multidimensional behaviors by selecting one or more activities in association with selected ones of time criteria, frequency criteria, numerical instance criteria, or group association information linkable with Boolean expressions to define the conditional rules.

17. The apparatus of claim 11, wherein the processing circuitry is further configured to cause the apparatus to monitor and determine whether to generate the reward via an entity remote from a service platform hosting the web site.

18. The apparatus of claim 11, wherein the processing circuitry is further configured to cause the apparatus to monitor and determine whether to generate the reward via an entity locally at a service platform hosting the web site.

19. The apparatus of claim 11, wherein the processing circuitry is further configured to cause the apparatus to generate an indication to a user in response the user activity satisfying one or more of the conditional rules.

20. The apparatus of claim 11, wherein the processing circuitry is further configured to cause the apparatus to enable a user of the web site to access a listing of rewards in the reward lexicon along with an explanation of the conditional rules required to be satisfied for achievement of each respective reward.
